(19) United States
(12) Patent Application Publication
(10) Pub. No.: US 2020/0216079 A1
(43) Pub. Date: Jul. 9, 2020

(54) SYSTEMS AND METHODS FOR DRIVER PROFILE BASED WARNING AND VEHICLE CONTROL

(71) Applicant: Byton North America Corporation, Santa Clara, CA (US)

(72) Inventor: PANKAJ MAHAJAN, West Bloomfield, MI (US)

(21) Appl. No.: 16/240,451

(22) Filed: Jan. 4, 2019

(51) Int. Cl. B60W 40/09; G05D 1/00; B60W 50/16

(52) U.S. Cl. CPC B60W 40/09; G05D 1/0061; B60W 2050/146; B60W 50/16; G05D 2201/0213; G05D 1/0088

(57) ABSTRACT

Disclosed is a method and apparatus for controlling operation of an autonomous vehicle based on driver operation profiles. The method may include capturing, from a plurality of vehicle systems, driver-vehicle interaction data from the plurality of vehicle systems indicative of a plurality of driving characteristics of a driver of the autonomous vehicle. The method may also include determining, by a processing system, when the driver-vehicle interaction data deviates from a driver operation profile stored in the memory. Furthermore, the method may include controlling, by the processing system operation of at least one system of the autonomous vehicle in response to determining that the driver-vehicle interaction data deviates from the driver operation profile.

### FIELD

The disclosed embodiments relate generally to vehicle systems and in particular, but not exclusively, to enabling vehicle operation control and warning based on driver profiles.

### BACKGROUND

Vehicles, such as cars, trucks, trains, drones, etc., have historically been controlled by human operators. That is, a human operator would control speed and direction of the vehicle during the entirety of the vehicle's operation. The human operator would continue to exercise control over the vehicle regardless of how safely they might be operating the vehicle, or how distracted they might be.

Some systems, such as U.S. Pat. No. 8,564,442, describe the determination of hand position of a human operator on a steering wheel. Then, based on comparison of the determined hand position to hand positions predetermined to be acceptable, may trigger a warning and/or record detected unsafe hand condition. The rigid conformance of monitored hand positions to pre-authorized acceptable hand positions does not properly reflect actual human operator interactions with a vehicle. Thus, warnings or other operations based on such a rigid pre-determined condition is not always appropriate, and may actually distract a human operator away from their normal and controlled operation of a vehicle.

### BRIEF DESCRIPTION OF THE DRAWINGS

FIG. 1 is a block diagram of an exemplary system architecture for selectively controlling operation of one or more systems of a vehicle based on driver operation profiles;

FIG. 2 is block diagram of one embodiment of a system including a vehicle for selectively controlling operation of one or more systems of the vehicle based on driver operation profiles;

FIG. 3 is a flow diagram of one embodiment of a method for controlling operation of an autonomous vehicle based on driver operation profiles;

FIG. 4 is a flow diagram of an embodiment of a method for driver operation profile generation and/or updating; and

FIG. 5 is a flow diagram of an embodiment of a method for controlling operation of an autonomous vehicle based on a driver operation profile.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

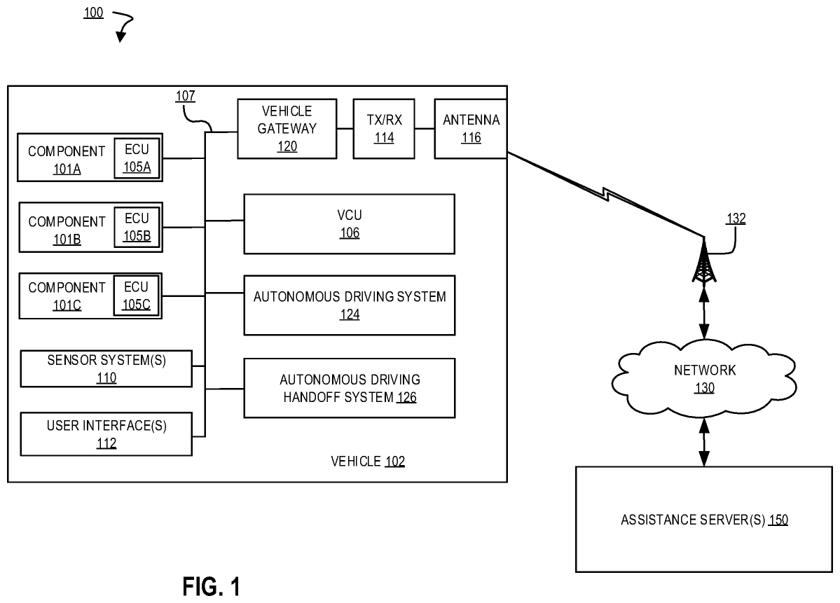

FIG. 1 is a block diagram of an exemplary system architecture 100 for selectively controlling operation of one or more systems of a vehicle 102 based on driver operation profiles. As discussed in greater detail herein, one or more operational characteristics, such as steering wheel hand position, number of hands on wheel, grip pressure, perspiration, etc. are captured for a vehicle operator when vehicle 102 is determined to be operated within predetermined parameters (e.g., satisfying traffic laws, maintaining a driving lane, not getting within a certain distance of another lane, etc. as determined by an driver assistance system of the vehicle). Additional operational characteristics of the operator, such as head position, eye position, steering wheel inputs (e.g., oscillation, deviation from trajectory, etc.), pedal inputs (e.g., brake/accelerator tapping, braking pedal depression force, acceleration pedal depression force), etc. may also be captured during operation. The operational characteristics are accumulated for generation of variables in a driver operation profile that reflects natural driving habits of a user of vehicle 102. For example, DriverA and DriverB may each operate a vehicle 102 within traffic law requirements, but handle the vehicle in different ways when doing so. Thus, each unique user of vehicle 102 may have their own driver operation profile that reflect unique and personal user operational characteristics as defined by the respective variables in the driver operation profiles.

Then, during operation of the vehicle 102, one or more vehicle sensor systems of the vehicle 102 may be used to capture data associated with the driver operation profile variables. For example, capacitive sensors embedded within or one a steering wheel may be indexed relative to the steering wheel so that hand position may be determined by capacitance inputs. As another example, a two-dimensional or three-dimensional driver facing camera may capture image data of a driver, and by performing one or more image recognition processes, determine a hand position on the steering wheel, determine a head position (e.g., facing forward, facing left, facing right, etc.), as well as other inputs. Furthermore, additional sensor inputs, such as driver facing radar may be used when determining driver operation profile variables.

In one embodiment, a periodic and/or real time determination can be made based on the captured data and a driver operation profile associated with a current vehicle operator as to whether the vehicle is being controlled in a normal fashion. In embodiments, the driver profile may include one or more profile variables, for example, hand position, head position, and steering wheel input. As will be discussed herein, each operator of a vehicle may have different values for each variable. Thus, for example, a first user may typically operate a vehicle with their right hand applying a certain grip pressure. When it is detected that the user has placed two hands on wheel and/or their grip pressure has increased (e.g., their detected profile variable have changed beyond a mere tolerance/threshold, such as deviation beyond +/−10%), it may be determined that the vehicle is being operated in an abnormal manner for the current operator. In response to such a determination, one or more systems of the vehicle can be adjusted to perform autonomous and/or partially autonomous control of the vehicle 102, issue alerts (e.g. audible, visual, and/or haptic feedback), or a combination thereof. For example, an automated braking system can be adjusted to automatically assist operator braking and increase a distance between vehicle 102 and other vehicles on a roadway, an autonomous vehicle driving system may take over control of all operation of the vehicle, etc. in response to driver profile variable being outside of safe values. Therefore, embodiments as discussed herein enable different users of vehicle 102 to operate vehicle 102 in their own natural way. Furthermore, when it is detected that one or more variables associated with a current operator's driver operation profile is outside of acceptable value(s) (e.g., satisfying threshold value(s) associated with the variable(s) of a driver operation profile and/or having variable values associated with known unsafe driving), the vehicle 102 can partially and/or fully control various operations of the vehicle 102 until it is determined that the user has resumed their normal control of the vehicle 102.

In embodiments, the vehicle 102 may be a fully electric vehicle, partially electric (i.e., hybrid) vehicles, non-electric vehicles (i.e., vehicle with a traditional internal combustion engine). Furthermore, although described mostly in the context of automobiles, the illustrated systems and methods can also be used in other wheeled vehicles such as trucks, motorcycles, electronic bicycles, buses, trains, etc. It can also be used in non-wheeled vehicles such as ships, airplanes (powered or gliders), drones, and rockets.

In one embodiment, vehicle 102 includes one or more systems, such as components 101 each having an electronic control unit (ECU) 105, and each ECU 105 is communicatively coupled via a communications network 107 to a vehicle control unit (VCU) 106. The communications network 107 may be a controller area network (CAN), an Ethernet network, a wireless communications network, another type of communications network, or a combination of different communication networks. VCU 106 is also communicatively coupled to a plurality of sensor system(s) 110 for capturing data outside of the vehicle (e.g., a positioning system, a radio detection and ranging (RADAR) system, a light detection and ranging (LIDAR) system, an imaging system having one or more cameras that captures two-dimensional and/or three-dimensional image data outside of the vehicle, a sound navigation and ranging (SONAR) system, proximity sensors, weather sensors, light sensors, noise sensors, etc.), as well as for capturing data inside of the vehicle (e.g., capacitive, touch, pressure, moisture, etc. sensors in steering wheel, inward facing 2D and/or 3D camera systems, sensors in seats of the vehicle, etc.). VCU 102 is also communicatively coupled to a user interface(s) 112 (e.g., displays, audio systems, haptic feedback systems, etc.), an autonomous driving system 124 that fully and/or partially controls operation of vehicle 102 according to the data captured by sensor system(s) 110, and an autonomous driving handoff system 126 that analyzes variables associated with a driver operation profile for adjusting, as necessary, one or more autonomous driving functions of vehicle 102.

Components 101 are generally components of the systems of the vehicle 102. For example, components 101 can include adjustable seat actuators, power inverters, window controls, etc. Components 101 may also include automated driving system controllers, such as a braking assistance systems, adaptive headlight control systems, adaptive cruise control system, cornering brake assist systems, navigation system, autopilot systems, etc. that may be controlled by autonomous driving system 124 and/or VCU 106 in response to analysis of variables associated with a driver operation profile, as discussed herein.

Vehicle control unit (VCU) 106 is a controller including a microprocessor, memory, storage, and a communication interface with which it can communicate with components 101, sensor system(s) 110, user interface(s) 112, autonomous driving system 124, autonomous driving handoff system 126, and transceiver 114 via network 107. In one embodiment VCU 106 is the vehicle's 102 main computer, but in other embodiments it can be a processing component separate from the vehicle's main or primary computer. Transceiver 114 is communicatively coupled to an antenna 116, through which vehicle 102 can wirelessly transmit data to, and receive data from, remote systems such as assistance server(s) 150. In the illustrated embodiment, vehicle 102 communicates wirelessly via antenna 116 with a tower 132, which can then communicate via network 130 (e.g., a cellular communication network, a local area network, a wide area network, etc.) remote systems and/or other vehicle(s) (not shown).

In one embodiment, vehicle 102 includes vehicle gateway 120. Vehicle gateway 120 is a networking appliance that resides on vehicles communications network 107. Vehicle gateway 120 may include a network interface, processor, memory, and one or more processing modules. In one embodiment, vehicle gateway 120 may reside in VCU 106, as well as in other components with sufficient access to network 107, processing power, and memory resources to perform the operations described in greater detail herein.

In embodiments, autonomous driving system 124 selectively controls one or more components 101 to perform autonomous operation of vehicle 102. In embodiments, for example where vehicle 102 is a motor vehicle driving on a roadway, this can include autonomous driving system 124 controlling speed, lane maintenance assistance, lane changes, braking, navigation, obeying traffic laws, controlling vehicle trajectory relative to other vehicles, as well as other autonomous operations that control operation of vehicle 102 on a roadway. In embodiments, autonomous driving system 124 utilizes sensor data from the one or more sensor system(s) 110 to analyze the operating environment of vehicle 102. For example, the sensor data may enable autonomous driving system 124 to detect and track relative speed, course, trajectory, etc. of surrounding vehicles, determine whether surrounding vehicles are operating in a safe manner, determine weather reports, detect road conditions, capture two-dimensional and/or three-dimensional imaging data captured of vehicle's 102 surroundings, perform image recognition on the image data to determine content of street signs, traffic signs, roadway condition signs, construction signs, perform image recognition on the image data to identify and track pedestrians, as well as many other data capture and recognition processes that identity and model the surrounding operational environment of vehicle 102. The detailed analysis of the surrounding operational environment enables autonomous driving system 124 to autonomously (e.g., without operator intervention) or semi-autonomously (e.g., with operator cooperation) control operation of the motor vehicle to, for example, drive along a roadway.

In embodiments, vehicle 102 may be operated without autonomous driving system 124 (e.g., when not activated by a vehicle operator and/or when overridden by manual control of an operator). In embodiments, autonomous driving handoff system 126 utilizes sensor systems(s) 110 to monitor one or more operational characteristics of the vehicle operator. The sensor system(s) 110 monitored by autonomous driving handoff system 126 may be those sensors in a steering wheel of the vehicle (e.g., capacitive sensors, touch sensors, pressure, sensor(s), moisture sensor(s) that may be distributed about the steering wheel such that detected capacitance indicates hand position(s) relative to the wheel) that collect data indicative of one or more of hand position, number of hands on wheel, grip pressure, perspiration level, etc. while the operator is controlling the vehicle. Furthermore, additional sensors, such as inward facing 2D and/or 3D camera, radar, and/or other imaging systems, may also capture hand position(s) on a steering wheel, eye position, head position, posture, mouth movements, etc. of the operator of the vehicle (e.g., by performing image and object recognition processes based on input from the imaging system(s)). Additional systems, such as braking systems, acceleration systems, steering systems, may also provide input regarding a user's interactions with those systems (e.g., typical braking behavior, typical acceleration behavior, steering wheel directional maintenance or oscillation about a current trajectory, etc.). In embodiments, the sensor input and vehicle system input may be accumulated and stored as variables in a driver operation profile associated with the operator of the vehicle. In one embodiment, autonomous driving handoff system 126 accumulates the sensor data and other input associated with the operator when autonomous driving system 124 determines that certain operational parameters, such as satisfying a speed limit, maintaining a driving lane, etc. are satisfied. That is, the sensor and other data associated with a vehicle operator is accumulated during vehicle 102 operation. The autonomous driving system 124 determines speed limits, lane maintenance, distance between other vehicles, acceleration, braking, as well as other inputs associated with operation of the vehicle 102. When the operator input satisfies the autonomous driving standards (e.g., within speed limit, not too close to neighboring lanes, steering oscillation under a certain distance/frequency), the associated vehicle inputs or operational characteristics can be assumed to be indicative of normal and/or acceptable control characteristics of an operator when controlling vehicle 102.

The accumulation of sensor data and additional data associated with normal and/or acceptable operator input variables is then used by autonomous driving handoff system 126 to generate a plurality of variables and/or a combination of variables that define the driver operation profile for the operator of the vehicle (e.g. safe driving occurs when hands are at 3 and 9 on the wheel, and head is facing forward). Furthermore, in embodiments, operator input variables associated may also be associated with unsafe driving (e.g. not satisfying behaviors that would be performed by autonomous driving system 124), to detect when an operator's input variables should trigger a warning (e.g., unsafe driving occurs when one hand on wheel at 12 regardless of head position). Additionally, driver input variables that are not associated with accumulated user input may be associated with unknown safety during operation (e.g. which may or may not trigger warnings, notices, autonomous driving takeover, etc.).

In embodiments, the variables associated with operation of vehicle 102 may include two or more of hand position(s) (e.g., one handed driving and location on a steering wheel or two handed driving and associated hand locations, as determined from image recognition performed on input from one or more imaging systems of the vehicle), grip pressure (e.g., a force applied by one or more hands on steering wheel as measured by force sensors distributed on a steering wheel of vehicle), perspiration level (e.g., moisture on skin captured by moisture sensors of vehicle), head position (e.g., orientation and or direction relative to a roadway and/or driving direction as determined from image recognition performed on input from one or more imaging systems of the vehicle, as well as vehicle operation systems indicating direction of driving), eye position (e.g., orientation and or direction relative to a roadway as determined from image recognition performed on input from one or more imaging systems of the vehicle), average force applied to a brake pedal (e.g., as determined from a braking system and/or force sensors coupled with a braking system), average force applied to an accelerator pedal (e.g., as determined from an acceleration system and/or force sensors coupled with a braking system), frequency and/or magnitude in steering direction deviation by a steering wheel (e.g., as determined from a steering system and/or force sensors coupled with a steering wheel, column, etc.), etc. associated with the operator during operation of vehicle 102 within the predefined parameters. In embodiments any combination of operational characteristics can be used to establish a driver operation profile, as discussed herein. Furthermore, different vehicle operators may have different driver operation profiles defined by their own variables. For example, DriverX and DriverY may both be authorized operators of vehicle 102, both may have accumulated sensor data, and the generated variables for their respective driver operation profiles may differ based on how DriverX and DriverY exert control on vehicle systems.

In one embodiment, when a vehicle is started, autonomous driving handoff system 126 accesses a driver operation profile associated with an operator of the vehicle. For example, a key fob may provide an identifier associated with the key fob, a user may sign into the vehicle prior to operation (e.g., provide a username and/or password), select a driver operation profile from a menu displayed on user interface 112, etc. In embodiments, this profile may be downloaded from assistance server(s) 150 (e.g., when operator is a new operator of vehicle 102 but has an existing driver operation profile generated by another vehicle (not shown)). In embodiments, where a driver operation profile does not exist, a default or general driver operation profile may be used. The accessed driver operation profile includes a plurality of variable associated with the current vehicle operator and how that operator naturally controls the vehicle. Then, during operation of the vehicle 102, autonomous driving handoff system 126 collects sensor data from sensor system(s) 110, such as steering wheel sensors, inward facing imaging systems, vehicle systems (e.g., steering systems, braking systems, acceleration systems, etc.). Based on the collected sensor and/or other system data, autonomous driving handoff system 126 determines when one or more of the collected data deviates from one or more of the variables a threshold amount, e.g., beyond a tolerance associated with the variable (e.g. +/−10%) and/or whether the variable has a value associated with unsafe driving (e.g., a hand position in which an operator has previously exhibited unsafe driving). That is, when sensor data collected during operation of vehicle 102 deviates from a driver operation profile variable(s) by a predetermined threshold amount greater than a tolerance associated with the variable and/or has a value associated with unsafe driving, autonomous driving handoff system 126 may determine that one or more correct and/or remedial actions are to be taken. In embodiments, sensor data that deviates from a single variable may be enough to trigger a remedial and/or corrective action. In embodiments, the threshold is selected so that the deviation is significant to the associated variable (e.g., hand position that deviates a certain number of degrees from a position defined by driver operation profile variables, a steering pattern that oscillates about a vehicle trajectory above a certain amount indicating erratic steering, a perspiration level captured by a moisture sensor above a certain level indicating increased driver tension, or a collection of two or more deviations each above their respective thresholds, etc.). Furthermore, the values of associated variable may be associated with unsafe driving, such that when the variable values satisfy the unsafe driving condition, a warning and/or autonomous driving takeover may occur (e.g., safe driving occurs when one hand on the wheel at 6 o'clock, and unsafe driving occurs when one hand on the wheel at 12 o'clock).

In embodiments, in response to autonomous driving handoff system 126 detecting deviation of sensor data from one or more variables in a driver operation profile satisfying one or more associated threshold values and/or having a value associated with unsafe driving, autonomous driving handoff system 126 configures and/or adjusts one or more vehicle systems. In embodiments, the configuration and/or adjustment may include generation of a warning or notification by autonomous driving handoff system 126 for user interface(s) 112, such as displaying a warning message (e.g. return your hands to steering wheel, return eyes to road, control steering direction etc.), playing an audible warning (e.g. a chime or other audible sound), triggering a haptic feedback (e.g., vibrating a steering wheel, vibrating a seat, etc.), or a combination. The configuration and/or adjustment may also include adjusting one or more settings of automated vehicle control systems (e.g., adjusting an automated braking system to increase distance to a vehicle in front of vehicle 102, adjusting a lane maintenance system to increase control over maintaining a lane, adjusting a cruise control system that controls vehicle 102 speed, etc.), as well as handing off full autonomous control of vehicle 102 to autonomous driving system 124.

In embodiments, warnings, handoff of partial control, and full vehicle control handoff may be associated with deviation amount(s) satisfying different thresholds, different numbers of variables detected that satisfy unsafe driving conditions, different set(s) deviations and/or detected unsafe driving variables, etc. For example, a driver operation profile may be comprised of variables that define hand position, head position, and steering inputs, which as discussed herein have specific values for an operator associated with that operator's normal operation of vehicle 102 as determined using an autonomous driving system 124 to determine when traffic laws and operational characteristics are being satisfied. In embodiments, captured sensor data that deviates from any one variable or is associated with unsafe behavior may cause a warning to be rendered to a user. However, a set of two or more variable that deviate and/or associate with unsafe driving patterns may be associated with a first set of corrections/adjustments/warnings that adjust settings of one or more vehicle systems (e.g., automatic braking systems, automatic lane maintenance systems, etc.). In embodiments, the deviations beyond associated tolerances and/or association of variable with unknown or unsafe driving history may be combined and/or accumulated such that the more deviations and/or unsafe variable are encounter, remedial actions can be escalated from passive warnings to vehicle takeover by the autonomous driving system 124.

In embodiments, autonomous driving handoff system 126 continues to monitor the sensor system(s) 110 during operation of vehicle 102. When the monitored sensor data indicates that the operational characteristics of the operator have returned to normal (e.g. have values associated with safe driving and/or within tolerances of those values), the autonomous driving handoff system 126 may remove the adjustments (e.g., remove warning displays, return full and/or partial control to an operator), etc. In embodiments, the return of monitored operational characteristics is indicative of the operator returning to normal control of vehicle 102.

In embodiments, driver operation profiles associated with different vehicle operators may be established to reflect natural and individual vehicle operation control behaviors. Furthermore, each driver operation profile may be defined by a plurality of variables, so that a wide range of operational characteristics can be considered for each operator. Thus, the normal operation behaviors of unique operators are able to determine how vehicle 102 will react during operation of a vehicle. Such flexibility better reflects human behavior, and ensures a more realistic and pleasurable driving experience for operators of vehicle 102.

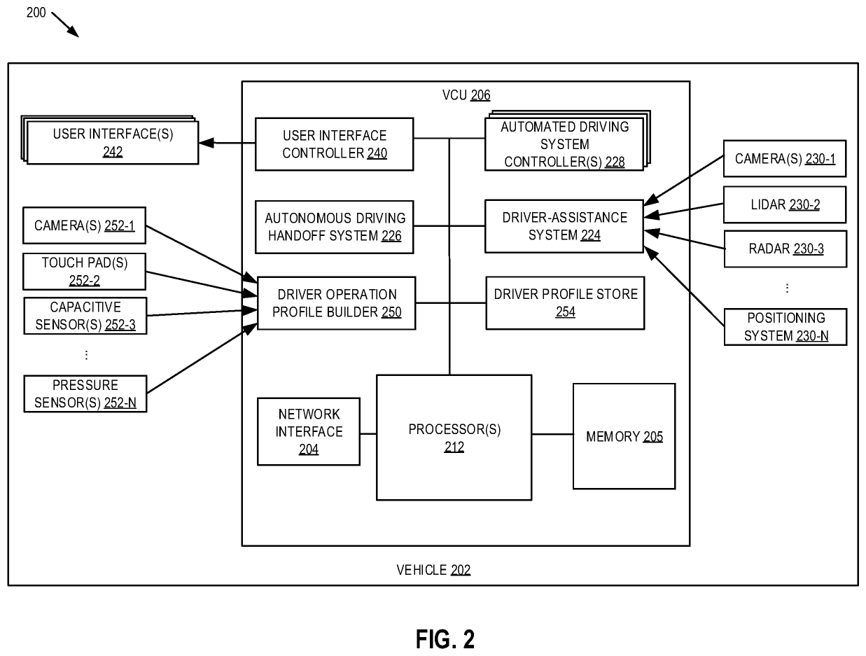

FIG. 2 is block diagram of one embodiment of a system 200 including a vehicle 202. Vehicle 202 provides additional details for vehicle 102 discussed above in FIG. 1.

In one embodiment, vehicle 202 is a system, which may include one or more processor(s) 212, a memory 205, and a network interface 204. It should be appreciated that vehicle 202 may also include, although not illustrated, a user and/or hardware interface, vehicle controls, one or more power device(s) (e.g., vehicle battery), drive control system, one or more vehicle systems (e.g., VCUs, positioning systems, braking systems, steering systems, lane maintenance assistance systems, etc.), a propulsion system (e.g. an electric, gasoline, natural gas, hybrid, etc. powered motor), a steering system, a braking system, as well as other components typically associated with vehicles. Although only a single network interface 204 is illustrated, it is understood that network interface 204 may be capable of communicatively coupling vehicle 202 to any number of other vehicles and/or remote servers (e.g., assistance server(s)) using one or more wireless subsystems (e.g., Bluetooth, WiFi, Cellular, or other networks) to transmit and receive data streams through one or more communication links.

In embodiments, memory 205 of vehicle 202 may be coupled to processor(s) to store instructions for execution by one or more processors, such as processor(s) 212. In some embodiments, the memory is non-transitory, and may store one or more processing modules. In one embodiment, memory 205 of vehicle 202 may store one or more processing modules, such as a driver-assistance system 224, an autonomous driving handoff system 226, a user interface controller 240, automated driving system controller(s) 228, driver operation profile builder 250, and driver profile data store 254 to implement embodiments described herein.

It should be appreciated that the embodiments as described herein may be implemented through the execution of instructions, for example as stored in memory or other element, by processor(s) 212 and/or other circuitry of vehicle 202. Particularly, circuitry of vehicle 202, including but not limited to processor(s) 212, may operate under the control of a program, routine, or the execution of instructions to execute methods or processes in accordance with the aspects and features described herein. For example, such a program may be implemented in firmware or software (e.g. stored in memory 205) and may be implemented by processor(s) 212, and/or other circuitry. Further, it should be appreciated that the terms processor, microprocessor, circuitry, controller, engine, manager, generator, etc., may refer to any type of logic or circuitry capable of executing logic, commands, instructions, software, firmware, functionality and the like.

Further, it should be appreciated that some or all of the functions, engines, modules, controller, systems, etc. described herein may be performed by vehicle 202 itself and/or some or all of the functions, engines or modules described herein may be performed by another system connected through network interface 204 to vehicle 202. Thus, some and/or all of the functions may be performed by another system, and the results or intermediate calculations may be transferred back to vehicle 202. In some embodiments, such other system may comprise a server (not shown).

In one embodiment, vehicle 202 includes a plurality of sensors, such as inward facing sensors (e.g., camera(s) 252-1 that capture image data of a driver during operation of vehicle 202, steering wheel touch pad sensor(s) 252-2 distributed about known positions of the steering wheel such that touch detection by certain sensors indicate hand position(s) on the steering wheel, steering wheel capacitive sensor(s) 252-3 distributed about known positions of the steering wheel such that capacitance above a threshold amount (e.g. a calibrated capacitance associated with a hand, ½ hand, etc.) by certain sensors indicate hand position(s) on the steering wheel, steering wheel pressure sensor(s) 252-N that detect how much force is exerted on a steering wheel and at which sensors distributed at known positions on the steering wheel, as well as other sensors for monitoring a driver during operation of vehicle 202 such as moisture sensors, steering system inputs, pedal inputs, etc.), as well as outward facing sensors (e.g., camera(s) 230-1 to capture two-dimensional and/or three-dimensional image data of vehicle's 202 surrounding, a LIDAR system 230-2 and/or RADAR system 230-3 to perform ranging and object detection of objects proximate to vehicle 202, positioning system 230-N that provides global navigation satellite system based real world positioning data, as well as other sensors (e.g., light, temperature, weather, proximity, etc.)).

In embodiments, an operator of a vehicle may be identified when the vehicle is started, for example by driver operation profile builder 250. When the operator is identified, driver operation profile builder 250 may generate a new driver operation profile or update an existing driver operation profile (if one is stored in drive profile data store 254). In embodiments, data gathered by the inward facing sensor(s) during operation of vehicle 202 is provided to the driver operation profile builder 250. The driver operation profile builder 250 is responsible for monitoring, for the identified driver, the sensor data to establish and/or update a driver operation profile variables during operation of vehicle 202. In embodiments, the driver operation profile builder 250 consults driver assistance system 224 to determine whether vehicle 202 is operating within predefined parameters (e.g., satisfying traffic regulations, within a percentage of the speed limit, not bouncing back and forth within a lane, maintaining a predetermined distance from surrounding vehicles, as well as other factors that the driver assistance system 224 would utilize when controlling operation of the vehicle). When the predefined vehicle operation parameters are satisfied, an accumulation of the sensor inputs from inward facing cameras are used by driver operation profile builder 250 to generate and/or update driver operation profile variables, such as the normal, average, or expected value for the profile variables. The newly generated and/or updated driver operation profile is then stored in driver profile data store 254. For example, for a driver operation profile that includes hand position on steering wheel and head position relative to driving direction, the accumulation of sensor data can define sub-profiles such that each sub-profile represents a combination of the profile variables and an association with known safe, known unsafe, and unknown driving of an operator. For example, for a drive, one sub-profile may include hands at 3 and 9 and head facing in driving direction, wheel another sub-profile may include hands at 3 and 9 and head facing 90 degrees from driving direction. Based on historical driving data, such as that tracked by sensor systems and analyzed in view of driver-assistance system 224, each sub-profile can be associated with safe or unsafe driving. Then, when encountered during operation of the vehicle, an appropriate warning may be generated when values deviate from sub-profiles associated with safe driver operational variables.

In embodiments, autonomous driving handoff system 226 may then access the driver operation profile, for an identified driver, from driver profile data store 254. In embodiments, autonomous driving handoff system 226 utilizes the sensor data captured by driver operation profile builder 250 to determine when variables within the profile are satisfactory (e.g., indicating normal operational behavior of a current vehicle driver) and when one or more monitored sensor data deviate from the profile variables (e.g., indicating potential abnormal operational behavior of the current vehicle driver). In embodiments, captured sensor data from the inward facing sensor(s) is compared to the relevant profile variables to determine if any sensor data deviates a threshold amount from the expected profile variable and/or satisfies an unsafe profile variable value. For example, is a hand position a predefined percentage (e.g. +/−10%) away from a profile defined safe hand position for the identified driver and/or is determined hand position associated with safe, unsafe, or unknown driving. As another example, is skin moisture level a predefined percentage (e.g. +/−10%) above a profile defined skin moisture level for the identified driver. Other variables, as discussed herein, may be used as variables in a driver operation profile. In embodiments, when it is determined that one or more thresholds have been satisfied (e.g., deviation(s) satisfying a threshold amount beyond a tolerance of the variable) and/or it is determined that the variable satisfies an unsafe or unknown driving profile, autonomous driving handoff system 226 may initiate one or more actions.

In embodiments, autonomous driving handoff system 226 may generate a warning for one or more of user interface(s) 242. The user interfaces may include visual displays, audio systems, haptic feedback systems, etc. Furthermore, autonomous driving handoff system 226 may select one or more of the user interface(s) 242 based on which driver operation profile variable is currently experiencing abnormal conditions, and based on a magnitude of deviation. For example, a first display may be rendered indicative of a minor deviation in hand position (e.g., a display “Resume Hand Position on Steering Wheel”), while a second display may be rendered indicative of a more significant deviation in hand position (e.g., a display “Return Hands to Steering Wheel”).

In embodiments, depending on which driver operation profile variable(s) (e.g. safe, unknown, or unsafe variable values) and/or a magnitude of deviation from an expected value are detected, autonomous driving handoff system 226 may further configure and/or adjust one or more automated driving system controller(s) 228 (e.g., automated braking, automated lane maintenance, etc. systems) of the vehicle, as well as driver-assistance system 224. For example, deviation from one or more variables may be considered a significant departure from normal operational behavior defined by variables in a driver operation profile associated with the identified driver (e.g., their eye position may not be on the road, they may not have any hand on the steering wheel, their grip pressure meets/exceeds a threshold pressure, their perspiration level meets/exceeds a threshold perspiration level, etc.). Such a deviation may indicate to autonomous driving handoff system 226 that control of one or more vehicle systems should be given operational control of vehicle 202. In embodiments, such control handover may include adjusting settings of the automated driving system controller(s) 228 to control how such systems react to the data captured by outward facing sensor(s), and impact user control exerted on such systems (e.g., a user may still maintain braking control, but automated braking systems are adjusted to provide increased vehicle spacing). In embodiments, such control handover may include giving full or partial autonomous driving control to driver-assistance system 224 (e.g., based on detected profile variable deviations, vehicle 202 is switched to a fully autonomous driving mode for the safety of the current vehicle occupants and for surrounding vehicles). In embodiments, driver-assistance system 224 may be configured to select which systems are to be adjusted, activated, and given control based on which profile variable(s) deviate by threshold amounts and whether those variable impact the system (e.g., a braking pattern that is not normal for an operator may cause driver-assistance system 224 to operate/configure an automated braking system, whereas a head position not facing a driving direction may be associated with a combination of vehicle systems causing driver-assistance system 224 to operate/configure steering systems, acceleration systems, trajectory systems, etc.), a determined magnitude of the deviation(s), how long a deviation has been detected, a deviation combined with detected driving behavior not satisfying predetermined characteristic (e.g., not satisfying legal standards), etc.

When driver-assistance system 224 determines that the operational characteristics return to normal (e.g., the monitored sensor data is within expected ranges of driver operation profile variables associated with safe driving), the adjustments and/or control can be removed and/or adjusted back to give the vehicle operator an original level of vehicle control.

As discussed herein, driver profile store 254 may be used to store driver operation profiles for any number of authorized vehicle operators. The different profiles may be associated with key fob identifiers, user login credentials, facial or other biometric recognition, etc. Furthermore, in one embodiment, driver operation profile builder 250 may generate a query of a remote system (e.g., assistance server 150) to locate and/or download a driver operation profile generated for a new vehicle operator, and which was generated by another vehicle (not shown). Thus, vehicle 202 may utilize unique driver operation profiles for different drivers to enable each driver to exert their normal and nature command over a vehicle during operation. Furthermore, the remediate actions (e.g., warnings, autonomous takeover, automated driving system adjustments, etc.) are better able to respond to each driver's natural operational behaviors to, for example, not make unnecessary adjustments.

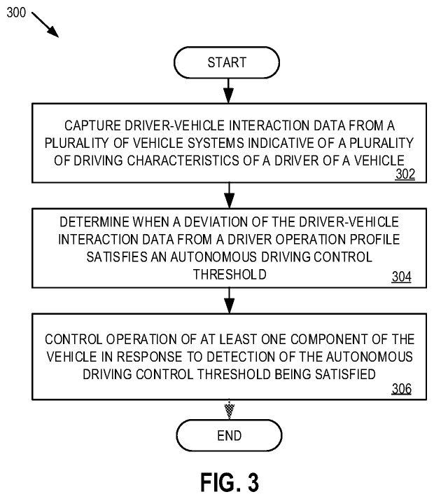

FIG. 3 is a flow diagram of one embodiment of a method 300 for controlling operation of an autonomous vehicle based on driver operation profiles. The method 300 is performed by processing logic that may comprise hardware (circuitry, dedicated logic, etc.), software (such as is run on a general purpose computer system or a dedicated machine), firmware, or a combination. In one embodiment, the method 300 is performed by a vehicle (e.g., vehicle 102 and/or 202).

Referring to FIG. 3, processing logic begins by capturing driver-vehicle interaction data from a plurality of vehicle systems indicative of a plurality of driving characteristics of a driver of a vehicle (processing block 302). In one embodiment, the plurality of vehicle systems can include sensor systems, such as steering wheel sensors (e.g., touch, capacitive, pressure, moisture, etc. sensors of a steering wheel that generate sensor data indicative of hand position on the steering wheel), imaging systems that capture image data of the driver during operation of the vehicle (e.g., which may be analyzed using image analysis and recognition techniques to detect, for example, hand position on steering wheel, head position, body position, etc. of an operator), as well as other sensor systems that capture data relevant to determining driver-vehicle interactions (e.g., vehicle control systems that provide data indicate of driver inputs to steering, braking, and acceleration systems). Additional vehicle systems, such as steering systems indicating movement, velocity, direction, acceleration, etc. of the vehicle's steering wheel, pedal systems indicating activation, force, speed, etc. of pedals of a vehicle, as well as other vehicle systems indicating driver-vehicle interactions. In embodiments, the driver-vehicle interaction data is captured while driver operates the vehicle.

As discussed herein, the vehicle may be an autonomous fully or semi electric car. A driver-assistance system may perform autonomous driving operations (e.g., object detection, recognition, tracking, predictions, controlling acceleration, speed, braking, and navigation, etc.) without input from an operator. Furthermore, other vehicle systems perform automated functions, such as braking assistance, to enhance driver commands while the driver controls the vehicle. Thus, processing logic determines when a deviation of the driver-vehicle interaction data from a driver operation profile satisfies an autonomous driving control threshold (processing block 304). For example, the threshold is satisfied when the value deviates from a tolerance associated with the variable, such as deviation +/−10% of the variable's expected value. As discussed herein, a driver operation profile comprises a plurality of variables that define expected, normal driver-vehicle interactions (e.g., two or more of hand position(s) on steering wheel, grip pressure, skin moisture level, head position, eye position, steering system input, pedal system input, etc.) for the current driver of the vehicle, as well as values associated with known unsafe driving, and optionally values associated with unknown operator driving behaviors. That is, the driver operation profile defines the normal and natural operational characteristics of a vehicle, and optionally unsafe and/or unknown operational characteristics of the vehicle. Thus, one or more deviations from a driver's normal behavior/operation characteristics may occur, such as a different hand position, increased or decreased grip pressure, increased skin moisture, steering wheel oscillation about a current trajectory, increased braking, etc. Some of the deviations may be normal due to variation in human behavior (e.g., within a tolerance of a known safe operational characteristic, two values for the same operational characteristic each associated with safe driving, etc.), while other deviations are abnormal indicating lack of vehicle control, lack of focus, or other conditions (e.g., deviation beyond a tolerance and associated with a known unsafe driving pattern as determined by an autonomous driving system). In one embodiment, the autonomous driving control thresholds may be configured to reflect when such abnormal deviations occur (e.g., a hand position that differs by a predefined number of degrees from an expected condition beyond a tolerance associated with the variable, a grip pressure greater than a predefined expected grip pressure beyond a tolerance associated with the variable, etc.) and/or when a variable satisfies a known unsafe driving characteristic.

When such a deviation occurs, processing logic controls operation of at least one component of the vehicle in response to detection of the autonomous driving control threshold being satisfied (processing block 304). In embodiments, the control can include rendering a warning on a vehicle display, activating a haptic feedback device, playing a sound, etc. to warn a driver to return to their normal operational behavior. In embodiments, and based on a magnitude and/or number of deviations, more control may be exercised by processing logic, such as adjusting settings of automated vehicle control systems and/or activating a partially autonomous driving mode of vehicle (e.g., to assist or augment a driver's inputs for operating the vehicle), or activating a fully autonomous driving mode of vehicle (e.g., to take over control of vehicle regardless of current driver inputs). As discussed herein, the control is returned to the driver and user interface warnings, sounds, etc. turned off, when the driver-vehicle interaction data no longer satisfies the thresholds, which indicates driver operation of the vehicle has returned to normal as defined by their driver operation profile.

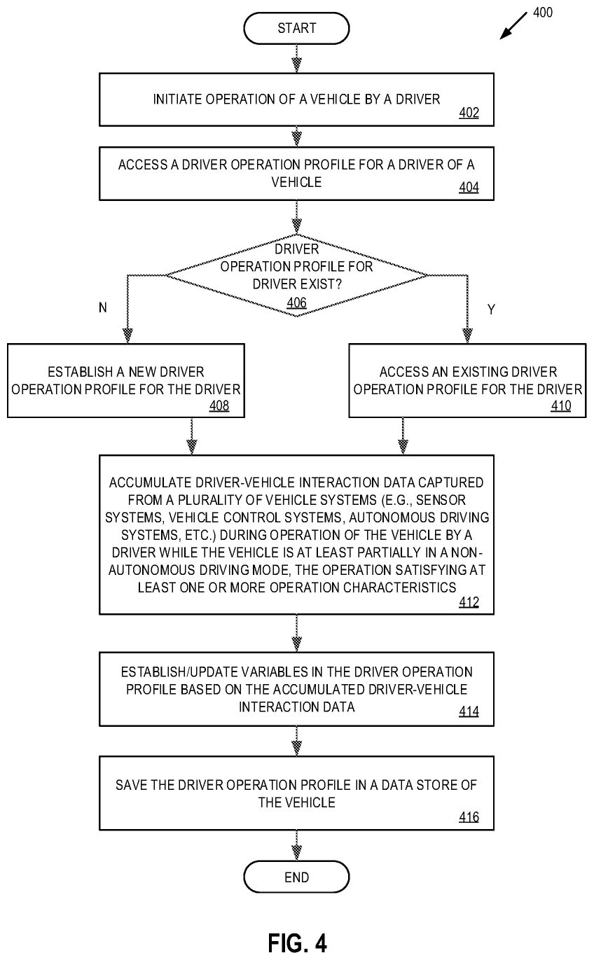

FIG. 4 is a flow diagram of an embodiment of a method for driver operation profile generation and/or updating. The method 400 is performed by processing logic that may comprise hardware (circuitry, dedicated logic, etc.), software (such as is run on a general purpose computer system or a dedicated machine), firmware, or a combination. In one embodiment, the method 400 is performed by driver operation profile builder of a vehicle (e.g., driver operation profile builder 250 of vehicle 102 and/or 202).

Referring to FIG. 4, processing logic begins by initiating operation of a vehicle by a driver (processing block 402). Processing logic then accesses a driver operation profile for a driver of the vehicle (Processing block 404). As discussed herein, each driver may have their own unique driver operation profile, which may be associated with an identifier of the driver. For example, a key fob identifier for a key fob used by the driver, login credentials, biometric data, etc. may provide identification data for identifying a current driver of the vehicle. In embodiments, the identifier may then be used to locate a drive operation profile in a data store (e.g., driver profile data store 254) of vehicle or at a remote system (e.g., assistance server(s) 150).

When a driver profile for the driver exists, processing logic accesses the driver operation profile (processing block 410), which can be updated/refined using the operations discussed herein. When a driver profile for the driver does not exist, processing logic establishes a new driver operation profile for the driver (processing block 408), such as by allocating a new profile in a driver profile data store, and generating profile variables using the operations discussed herein.

Processing logic accumulates driver-vehicle interaction data captured from a plurality of vehicle systems during operation of the vehicle by a driver while the vehicle is at least partially in a non-autonomous driving mode, where the operation satisfies at least one or more operation characteristics (processing block 412). As discussed herein, the driver-vehicle interaction data may be captured from a plurality of different inward facing sensor systems, as well as from other vehicle systems. Furthermore, because the driver-vehicle interaction data will be used to control the vehicle, the accumulation of such data occurs when the operation of the vehicle satisfies operation characteristic, such as operation that satisfies vehicle safety codes, operation that satisfies community norms, operation that satisfies safety conditions, etc. as determined by, or as would be consistent with, an autonomous driving system of the vehicle.

Processing logic then establishes/updates variables in the driver operation profile based on the accumulated driver-vehicle interaction data (processing block 414). In embodiments, the driver-vehicle interaction data may be accumulated over a period of time so that an average, normalized, etc. value for the profile variables can be established, and so that variable associated with known safe driving and known unsafe driving may be established. For example, based on a plurality of hand position and grip pressure measurements collected by processing logic, an expected (e.g., average, mean, etc.) value forming a hand position variable and a grip pressure variable can be generated for the driver's driver operation profile. As another example, more than one sensor system may provide input to the same variable, such capacitance sensing and image based analysis for determining hand position on a steering wheel as either a redundancy and/or cross-check of a given operational characteristics value. Furthermore, as discussed herein, there may be little to no pre-conditions on the variable values, and thus the variables generated form the accumulated data will accurately reflect the nature operational characteristics of a driver of the vehicle. Furthermore, profile variables may be defined for one or more sub-profiles, where each sub-profile is either associated with safe, unsafe, or unknown driving characteristics of an operator. That is, if current operational characteristic values (e.g. hand position, head position, steering input, etc.) are detected when an operator is operating the vehicle in a manger that is not consistent with how an automated driving system would control the vehicle, the values may be used to established or update a sub-profile or variable in a profile to reflect the unsafe driving. Similarly, sub-profiles and/or variables in a profile may be associated with values when safe driving occurs. In embodiments, where sub-profiles are established, each sub-profile may be associated with a different combination of tracked operational characteristics, so that each sub-combination can define safe, unsafe, or unknown driving behavior of an operator.

Processing logic then saves the driver operation profile, including the generated and/or update variables, in a data store (e.g., the driver profile data store 254, a data store of assistance server(s) 150, another location, or a combination of locations). In embodiments, processing logic may then access the driver operation profile for controlling operation of one or more vehicle systems.

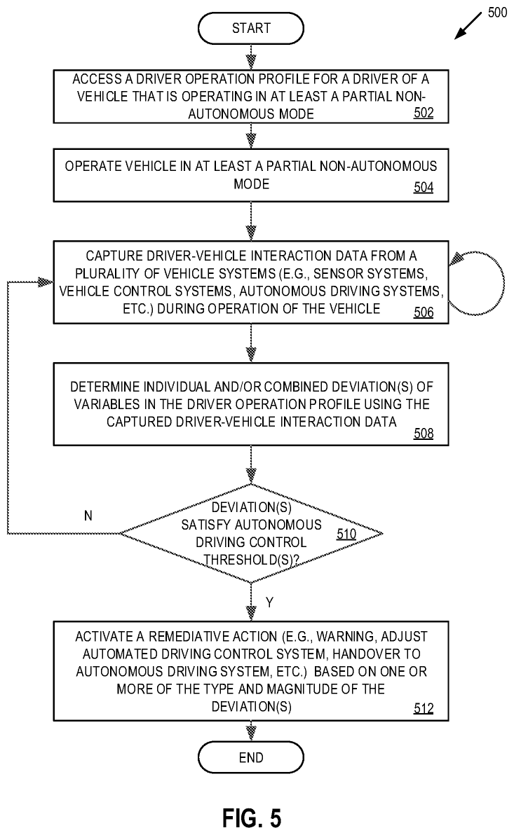

FIG. 5 is a flow diagram of an embodiment of a method 500 for controlling operation of an autonomous vehicle based on a driver operation profile. The method 500 is performed by processing logic that may comprise hardware (circuitry, dedicated logic, etc.), software (such as is run on a general purpose computer system or a dedicated machine), firmware, or a combination. In one embodiment, the method 500 is performed by a driver operation profile builder and an autonomous driving handoff system of a vehicle (e.g., driver operation profile builder 250 and autonomous driving handoff system 126 and/or 226 of vehicle 102 and/or 202).

Referring to FIG. 5, processing logic begins by accessing a driver operation profile for a driver of a vehicle that is operating in at least partial non-autonomous mode (processing block 502). In embodiments, processing logic will utilize driver operation profile data to control vehicle operation when the driver is asserting some control over operation of the vehicle. Processing logic therefore operates the vehicle in at least the partial non-autonomous mode (processing block 504), and captures driver-vehicle interaction data from a plurality of vehicle systems (e.g., sensor systems, vehicle control systems, autonomous driving systems, etc.) during operation of the vehicle (processing block 506). In embodiments, the capture of driver-vehicle interaction data is performed periodically and/or continuously during operation of the vehicle to reflect real-time or near real-time driver inputs to the vehicle.

In one embodiment, from the captured driver-vehicle interaction data, processing logic determines individual and/or combined deviation(s) of variables in the driver operation profile using the captured driver-vehicle interaction data (processing block 508). In embodiments, the deviations may be value based deviations, percentage deviations, statistical deviations, or other deviations from one or more of the variables in the driver operation profile beyond a tolerance. Furthermore, the deviations may be values associate with unknown and/or unsafe driving patterns of a vehicle operator. When no deviations are detected that satisfy autonomous driving control threshold(s) (e.g., no significant deviations or values satisfying an unsafe driving variable) (processing block 510), processing logic returns to processing block 506 to continue to capture driver-vehicle interaction data.

When deviations are detected that satisfy autonomous driving control threshold(s) (e.g., existence of one or more significant deviations and/or operational characteristics having variables associated with unsafe driving) (processing block 510), processing logic activates a remediative action (e.g., a user interface warning, adjusts an automated driving control system, performs a handover of vehicle control to an autonomous driving system, or a combination of actions) based on one or more of the type and magnitude of the deviation(s) (processing block 512). In embodiments, driver operation profiles include a plurality of variables associated with driver vehicle interactions (e.g., hand position, grip pressure, moisture content, eye position, head position, steering wheel input, pedal system input, etc.), where each variable may be associated with its own thresholds and/or values. Furthermore, specific variables in the driver operation profile, such as for example hand position, may be considered as significant (e.g., deviation from this variable alone may trigger any of the remediate control actions). As another example, specific variables may trigger remediate actions in combination with other variables (e.g., grip pressure above a certain value may not trigger autonomous driving handover, but grip pressure and perspiration together may trigger autonomous driving handover). The driver operation variables, combinations of variables, and thresholds may vary depending on implementation. Furthermore, the driver operation variables, combinations of variables, and thresholds may vary based on real time conditions experienced by the vehicle (e.g., weather conditions, traffic conditions, sensor data, etc.).

As discussed herein, driver operation profiles may be used to control vehicle systems to, for example, take remediative and/or correction actions based on monitored real-time driver-vehicle interactions. Furthermore, each driver operation profile is associated with individual drivers. Therefore, each driver operation profile generated and used according to the description herein reflects the natural driver-vehicle interactions when a vehicle is operated having predetermined characteristics (e.g., when operation satisfies traffic safety regulations). As such, control exercised on a vehicle, such as triggering a warning, adjusting braking distance of an automated braking system, handing over vehicle control to an autonomous driving system, etc., is triggered when the normal and natural driver-vehicle interactions deviate from profile values (e.g., the driver-vehicle interactions for a specific driver are outside of expected values). The operation of the vehicle is therefore improved in that it can more accurately respond to the natural driving patterns of different drivers based on a plurality of different factors. From the improved operation, safety for the occupants of the vehicle, as well as occupants of other vehicles, is also improved. That is, one driver's deviation for a driver operation profile variable may not be the same as another driver's deviation, and corrective/remediative action can be taken for each driver based on their unique driver-vehicle interaction patterns.

Those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the methods, systems, and apparatus of the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An autonomous vehicle, comprising:
a memory;
a plurality of vehicle systems; and
a processor coupled with the memory and the plurality of vehicle systems, the processor configured to:
capture driver-vehicle interaction data from the plurality of vehicle systems indicative of a plurality of driving characteristics of a driver of the autonomous vehicle,
determine when the driver-vehicle interaction data deviates from a driver operation profile stored in the memory, and
control operation of at least one system of the autonomous vehicle in response to determining that the driver-vehicle interaction data deviates from the driver operation profile.

2. The autonomous vehicle of claim 1, wherein the processor configured to control operation of the at least one system of the autonomous vehicle in response to determining that the driver-vehicle interaction data deviates from the driver operation profile, comprises the processor configured to:
generate a user interface alert, wherein the user interface alert comprise one or more of a graphical user interface alert, an audio alert, a haptic alert, or a combination thereof; and
stop the user interface alert in response to detection that the driver-vehicle interaction data no longer deviates from the driver operation profile.

3. The autonomous vehicle of claim 1, wherein the at least one system of the autonomous vehicle comprises an autonomous driving system, and wherein the processor configured to control operation of the at least one system of the autonomous vehicle, comprises the processor configured to:
adjust a setting of the autonomous driving system that partially controls at least one operation of the autonomous vehicle;
control the at least one operation of the autonomous vehicle by the autonomous driving system based on the adjustment to the setting of the autonomous driving system and further based an input of the driver with respect to the at least one operation; and
revert full control of the autonomous vehicle to the driver for controlling the at least one operation in response to detection that driver-vehicle interaction data no longer deviates from the driver operation profile.

4. The autonomous vehicle of claim 3, wherein the autonomous driving system comprises an autonomous braking system, an autonomous cruise control system, a lane maintenance assistance system, or a combination thereof.

5. The autonomous vehicle of claim 1, wherein the processor configured to control operation of the at least one system of the autonomous vehicle, comprises the processor configured to:
transfer control of the autonomous vehicle from the driver to an autonomous driving system executed by the processor to control at least one operation of the vehicle;
control the at least one operation of the autonomous vehicle by the autonomous driving system regardless of driver input associated with the at least one operation, and
transfer control from the autonomous driving system to the driver in response to detection that the driver-vehicle interaction data no longer deviates from the driver operation profile.

6. The autonomous vehicle of claim 5, wherein the autonomous driving system controls all operations of the autonomous vehicle using a fully autonomous driving mode of the autonomous vehicle until the driver-vehicle interaction data no longer deviates from the driver operation profile.

7. The autonomous vehicle of claim 1, wherein the driver operation profile for the driver of the autonomous vehicle comprises a plurality of variables generated for driver-vehicle interactions from the data captured from the plurality of vehicle systems, and wherein values of the plurality of variables are generated by an accumulation of captured driver-vehicle interaction data during operation of the autonomous vehicle by the driver when the operation is determined to have one or more operational characteristics.

8. The autonomous vehicle of claim 7, wherein the one or more operational characteristics are operational characteristics established by an autonomous driving system of the autonomous vehicle.

9. The autonomous vehicle of claim 7, wherein a second driver operation profile is generated for a second driver of the autonomous vehicle from a second accumulation of captured driver-vehicle interaction data during operation of the autonomous vehicle by the second driver when the operation is determined to have the one or more operational characteristics, and wherein variables defining the driver operational profile for the driver and the second driver operational profile for the second driver are different.

10. The autonomous vehicle of claim 1, wherein the plurality of vehicle systems that capture the driver-vehicle interaction data comprise one or more sensor systems, the one or more sensor systems comprising an imaging system that captures image data of the driver during operation of the autonomous vehicle, a sensor system that detects position of one or more hands of the driver on a steering wheel of the autonomous vehicle, or a combination thereof.

11. The autonomous vehicle of claim 1, wherein the plurality of vehicle systems that capture the driver-vehicle interaction data comprise one or more of a steering system, a braking system, and an autonomous driving system.

12. The autonomous vehicle of claim 1, further comprising:
an imaging system of the autonomous vehicle that captures image data of the driver during operation of the autonomous vehicle; and
the processor configured to:
perform object recognition on the image data captured by the imaging system to determine one or more of a hand position of the driver on the steering wheel and a head position the driver relative to a driving direction from the captured image data, and
determine that the driver-vehicle interaction data deviates from the driver operation profile when one or more of the determined hand position and the determined head position deviate from one or more values in the driver operation profile.

13. The autonomous vehicle of claim 1, further comprising:
a steering wheel comprising one or more sensors disposed about the steering wheel; and
the processor configured to:
determine a hand position of the driver from sensor data received form at least one of the sensors disposed about the steering wheel, and
determine that the driver-vehicle interaction data deviates from the driver operation profile when the determined hand position deviates from one or more values in the driver operation profile.

14. The autonomous vehicle of claim 1, further comprising:
an imaging system of the autonomous vehicle that captures image data of the driver during operation of the autonomous vehicle;
a steering wheel comprising one or more sensors disposed about the steering wheel; and
the processor configured to:
determine a first hand position of the driver from sensor data received form at least one of the sensors disposed about the steering wheel,
perform object recognition on the image data captured by the imaging system to determine one or more of a second hand position of the driver on the steering wheel and a head position the driver relative to a driving direction from the captured image data, and
determine that the driver-vehicle interaction data deviates from the driver operation profile when one or more of the determined first hand position, the determined second hand position, and the determined head position deviate from one or more values in the driver operation profile.

15. A method for controlling operation of an autonomous vehicle based on driver operation profiles, comprising:
capturing, from a plurality of vehicle systems, driver-vehicle interaction data from the plurality of vehicle systems indicative of a plurality of driving characteristics of a driver of the autonomous vehicle;
determining, by a processing system, when the driver-vehicle interaction data deviates from a driver operation profile stored in the memory; and
controlling, by the processing system operation of at least one system of the autonomous vehicle in response to determining that the driver-vehicle interaction data deviates from the driver operation profile.

16. The method of claim 15, wherein the processor system controlling operation of the at least one system of the autonomous vehicle in response to determining that the driver-vehicle interaction data deviates from the driver operation profile, comprises:
generating a user interface alert, wherein the user interface alert comprise one or more of a graphical user interface alert, an audio alert, a haptic alert, or a combination thereof; and
stopping the user interface alert in response to detection that the driver-vehicle interaction data no longer deviates from the driver operation profile.

17. The method of claim 15, wherein the at least one system of the autonomous vehicle comprises an autonomous driving system, and wherein controlling operation of the at least one system of the autonomous vehicle, comprises:
adjusting a setting of the autonomous driving system that partially controls at least one operation of the autonomous vehicle;
controlling the at least one operation of the autonomous vehicle by the autonomous driving system based on the adjustment to the setting of the autonomous driving system and further based an input of the driver with respect to the at least one operation; and
reverting full control of the autonomous vehicle to the driver for controlling the at least one operation in response to detection that driver-vehicle interaction data no longer deviates from the driver operation profile.

18. The method of claim 17, wherein the autonomous driving system comprises an autonomous braking system, an autonomous cruise control system, a lane maintenance assistance system, or a combination thereof.

19. The method of claim 15, wherein controlling operation of the at least one system of the autonomous vehicle, comprises:
transferring control of the autonomous vehicle from the driver to an autonomous driving system executed by the processor to control at least one operation of the vehicle;
controlling the at least one operation of the autonomous vehicle by the autonomous driving system regardless of driver input associated with the at least one operation, and
transferring control from the autonomous driving system to the driver in response to detection that the driver-vehicle interaction data no longer deviates from the driver operation profile.

20. The method of claim 19, wherein the autonomous driving system controls all operations of the autonomous vehicle using a fully autonomous driving mode of the autonomous vehicle until the driver-vehicle interaction data no longer deviates from the driver operation profile.

21. The method of claim 15, wherein the driver operation profile for the driver of the autonomous vehicle comprises a plurality of variables generated for driver-vehicle interactions from the data captured from the plurality of vehicle systems, and wherein values of the plurality of variables are generated by an accumulation of captured driver-vehicle interaction data during operation of the autonomous vehicle by the driver when the operation is determined to have one or more operational characteristics.

22. The method of claim 21, wherein the one or more operational characteristics are operational characteristics established by an autonomous driving system of the autonomous vehicle.

23. The method of claim 22, wherein a second driver operation profile is generated for a second driver of the autonomous vehicle from a second accumulation of captured driver-vehicle interaction data during operation of the autonomous vehicle by the second driver when the operation is determined to have the one or more operational characteristics, and wherein variables defining the driver operational profile for the driver and the second driver operational profile for the second driver are different.

24. The method of claim 15, wherein the plurality of vehicle systems that capture the driver-vehicle interaction data comprise one or more sensor systems, the one or more sensor systems comprising an imaging system that captures image data of the driver during operation of the autonomous vehicle, a sensor system that detects position of one or more hands of the driver on a steering wheel of the autonomous vehicle, or a combination thereof.

25. The method of claim 15, wherein the plurality of vehicle systems that capture the driver-vehicle interaction data comprise one or more of a steering system, a braking system, and an autonomous driving system.

26. The method of claim 15, further comprising:
capturing image data, with an imaging system of the autonomous vehicle, of the driver during operation of the autonomous vehicle;
performing, with the processing system, object recognition on the image data captured by the imaging system to determine one or more of a hand position of the driver on the steering wheel and a head position the driver relative to a driving direction from the captured image data; and
determining, with the processing system, that the driver-vehicle interaction data deviates from the driver operation profile when one or more of the determined hand position and the determined head position deviate from one or more values in the driver operation profile.

27. The method of claim 15, further comprising:
determining a hand position of the driver from sensor data received form at least one of the sensors disposed about a steering wheel of the autonomous vehicle; and
determining that the driver-vehicle interaction data deviates from the driver operation profile when the determined hand position deviates from one or more values in the driver operation profile.

28. The autonomous vehicle of claim 15, further comprising:
capturing image data, with an imaging system of the autonomous vehicle, of the driver during operation of the autonomous vehicle;
determining a first hand position of the driver from sensor data received form at least one of the sensors disposed about a steering wheel of the autonomous vehicle;
perform, with the processing system, object recognition on the image data captured by the imaging system to determine one or more of a second hand position of the driver on the steering wheel and a head position the driver relative to a driving direction from the captured image data; and
determining that the driver-vehicle interaction data deviates from the driver operation profile when one or more of the determined first hand position, the determined second hand position, and the determined head position deviate from one or more values in the driver operation profile.

29. A non-transitory machine readable storage medium having instructions stored thereon, which when executed by a processing system of an autonomous vehicle, causes the processing system to perform one or more operations for controlling operation of the autonomous vehicle based on driver operation profiles, the one or more operations comprising:
capturing, from a plurality of vehicle systems, driver-vehicle interaction data from the plurality of vehicle systems indicative of a plurality of driving characteristics of a driver of the autonomous vehicle;
determining, by the processing system, when the driver-vehicle interaction data deviates from a driver operation profile stored in the memory; and
controlling, by the processing system operation of at least one system of the autonomous vehicle in response to determining that the driver-vehicle interaction data deviates from the driver operation profile.

30. The non-transitory machine readable storage medium of claim 29, wherein the processor system controlling operation of the at least one system of the autonomous vehicle in response to determining that the driver-vehicle interaction data deviates from the driver operation profile, comprises:
generating a user interface alert, wherein the user interface alert comprise one or more of a graphical user interface alert, an audio alert, a haptic alert, or a combination thereof; and
stopping the user interface alert in response to detection that the driver-vehicle interaction data no longer deviates from the driver operation profile.
